(19) United States
(12) Patent Application Publication
(10) Pub. No.: US 2011/0110579 A1
(43) Pub. Date: May 12, 2011

(54) SYSTEMS AND METHODS FOR PHOTOGRAMMETRICALLY FORMING A 3-D RECREATION OF A SURFACE OF A MOVING OBJECT USING PHOTOGRAPHS CAPTURED OVER A PERIOD OF TIME

(75) Inventor: Alan Walford, Vancouver (CA)

(73) Assignee: Eos Systems, Inc., Vancouver (CA)

(21) Appl. No.: 12/616,299

(22) Filed: Nov. 11, 2009

(51) Int. Cl. G06K 9/00; G06T 15/00

(52) U.S. Cl. 382/154; 345/419

(57) ABSTRACT

A method for creating a 3-D data set of a surface of a moving object includes rigidly coupling a reference frame with targets to the object such that a change in position or orientation of the object causes a corresponding change in the reference frame. A first photograph is captured of at least a portion of the object and at least some of the plurality of targets at a first camera location. A second photograph is captured of at least a portion of the object and at least some of the plurality of targets at a second camera position. The object moves between the capturing of the first photograph and the capturing of the second photograph. The captured photographs are input to a computing device that is configured and arranged to determine 3-D data points corresponding to the surface of the object captured in the photographs.

### FIELD

The present invention is directed to the field of photogrammetry. The present invention is also directed to systems and methods for photogrammetrically capturing a 3-D surface of a moving object using photographs captured over a period of time and a reference frame rigidly coupled to the moving object, as well as systems and methods for making and using the systems.

### BACKGROUND

Photogrammetry can be generally defined as the science of making measurements from photographs. Typically, a photogrammetric system employs one or more cameras and a computing device, such as a computer modeling system. The camera captures one or more photographs of one or more objects. The computing device correlates the photographs to create a 3-D reconstruction of the surface of the one or more objects. For example, a 3-D reconstruction may be a data set used for generating a contour map of the one or more objects.

### BRIEF DESCRIPTION OF THE DRAWINGS

Non-limiting and non-exhaustive embodiments of the present invention are described with reference to the following drawings, in which:

FIG. 1 is a schematic view of one embodiment of a system for capturing a plurality of photographs of one or more moving objects over time and using the photographs to photogrammetrically form a 3-D recreation of a surface of the one or more objects, according to the invention; and

FIG. 2 is a flow diagram generally showing one embodiment of a method for capturing a plurality of photographs of one or more moving objects over time and using the photographs to photogrammetrically form a 3-D recreation of a surface of the one or more objects, according to the invention.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take the meanings explicitly associated herein, unless the context clearly dictates otherwise. The phrase “in at least some embodiments” as used herein does not necessarily refer to the same embodiment, though it may. Furthermore, the phrase “in other embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Suitable computing devices typically include mass memory and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory, or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computing device.

Methods of communication between devices or components of a system can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and include any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

The present invention is directed to the field of photogrammetry. The present invention is also directed to systems and methods for photogrammetrically capturing a 3-D surface of a moving object using photographs captured over a period of time and a reference frame rigidly coupled to the moving object, as well as systems and methods for making and using the systems.

Typically, photogrammetry uses computing devices that match specific loci (i.e., data points) disposed on an object and appearing on multiple photographs to use as reference points to combine and correlate data from the photographs to form a data set corresponding to a series of measurements that may be used to form composite 3-D reconstruction of a surface of the photographed object. When the object captured in the photographs is a static object, the photographs may be captured over a period of time from either a single camera or a plurality of cameras. However, when the object is moving, the photographs are typically captured from a plurality of cameras at the same instant in time.

For example, in the case of static objects, photogrammetry is sometimes performed on distant static objects, using aerial photogrammetry, or on nearby static objects using close-range photogrammetry. Aerial photogrammetry typically involves mounting one or more cameras on an aircraft (with the cameras usually pointed vertically towards the ground) and capturing multiple photographs of the ground as the aircraft flies along a path. In the case of aerial photogrammetry, a single camera may be used to capture photographs because, when the aircraft is at a high altitude, the ground (i.e., the object) is static. When multiple overlapping photographs are captured of a static object, computing devices running correlation algorithms can be used to create a 2-D data set of measurements of the photographed object, in part, by matching specific loci (i.e., data points) disposed on the object and appearing on multiple photographs to use as reference points to combine the photographs and correlate data.

Close-range photogrammetry typically involves using hand-held or tripod-mounted cameras to acquire multiple photographs. As with aerial photogrammetry, close-range photogrammetry also can utilize computing devices running correlation algorithms to form a 2-D data set of measurements of the surface of the photographed object, in part, by matching specific loci (i.e., data points) disposed on the object and appearing on multiple photographs to use as reference points to combine the photographs and correlate data.

Typically, in the case of moving objects, multiple cameras are used that are synchronized to simultaneously capture photographs of the object. Thus, the movement of the object is irrelevant because the photographs were captured at the same moment in time and the computing device is able to locate matching loci on the photographs.

In the case of a movable object attempting to maintain a static position (e.g., a person attempting to hold still while photographs of the person are captured over time, or the like) it is generally preferred to capture multiple photographs at the same instant. When photographs are captured over time, small movements between captured photographs may have a detrimental effect on the photogrammetric process. It may be the case that a computing device that correlates data points on the photographed object may not be able to correlate the data points as accurately due to small shifts in the position or orientation of the object, thereby decreasing the accuracy of a data set of measurements of the surface of the object. It may even be the case that the computing device cannot correlate the data points at all.

When multiple photographs of a moving object are captured at the same instant, the accuracy of the generated data set may improve with improved synchronization of the capturing of the photographs. Cameras, camera-related equipment (e.g., tripods, cases, lenses, flashes, batteries, and the like), and synchronization equipment, however, can be bulky to carry around and expensive to purchase. Thus, it may be an advantage to generate a data set without needing synchronization equipment to ensure that multiple photographs are captured simultaneously. Additionally, it may be an advantage to be able to capture each of the photographs needed to generate a data set of a surface of a moving object using a single camera.

Systems and methods are described for capturing a plurality of photographs of one or more moving objects over time and using the photographs to photogrammetrically generate a data set of measurements of the surface of the one or more objects. In at least some embodiments, the data set may be used to form a displayable 3-D reconstruction of the one or more objects. In at least some embodiments, the data set may be used for analysis or for some other use.

A reference frame, on which a plurality of targets are disposed, is rigidly coupled to one or more moving objects. A first photograph is captured of at least a portion of more than one of the plurality of the targets and at least a portion of the one or more objects from a first camera location. In at least some embodiments, at least one of the position or the orientation of the one or more objects (and the rigidly coupled reference frame) is changed. A second photograph is captured of a portion of more than one of the plurality of the targets and at least a portion of the one or more objects in the changed position or orientation from a second camera location. In at least some embodiments, the first camera location and the second camera location are at different locations. A 3-D data set of a photographed surface of the one or more objects is then produced by first, determining the relative positioning of the first camera location to the targets in the first photograph, and the relative positioning of the second camera location to the targets in the second photograph; second, by correlating the first photograph with the second photograph; and third, by using triangulation methods to combine the relative positions of each camera location with the correlated data. In at least some embodiments, a 3-D recreation of the surface of the one or more objects is formed and displayed.

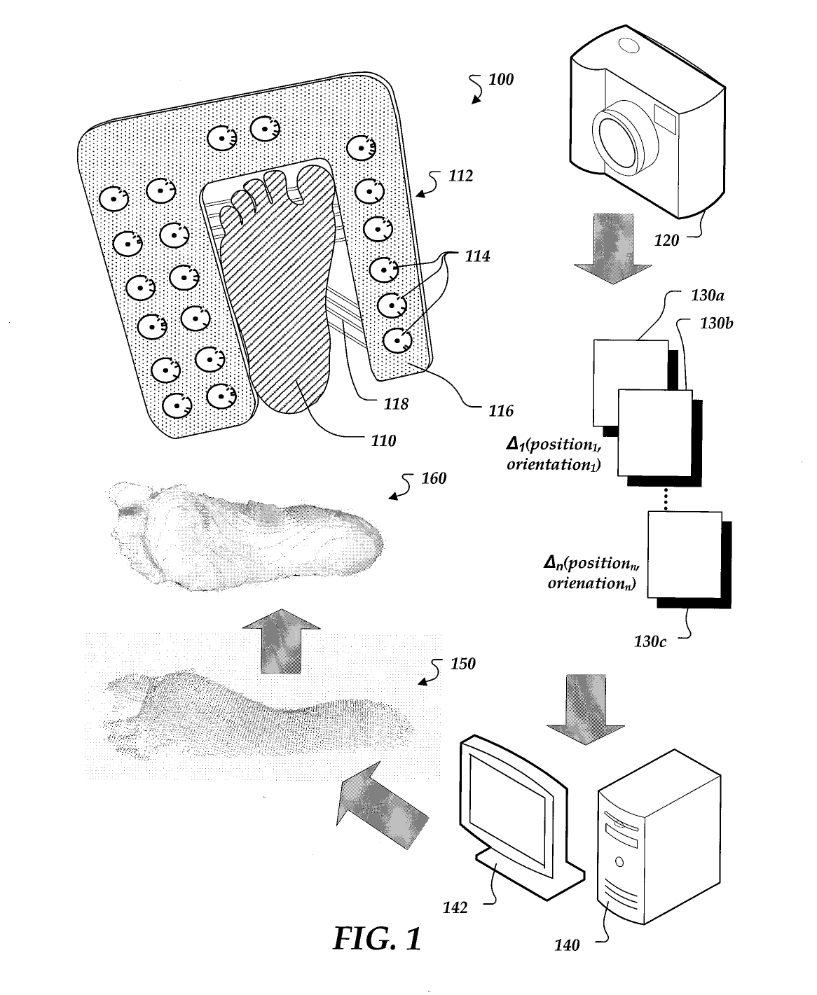

FIG. 1 is a schematic view of one embodiment of a system for capturing a plurality of photographs of one or more moving objects over time and using the photographs to photogrammetrically generate a data set of measurements of a surface of the one or more objects. The system 100 includes one or more objects 110 rigidly coupled to a reference frame 112, and at least one camera 120 for capturing photographs 130 of the one or more objects 110 and the reference frame 112. The system 100 also includes a computing device 140 for correlating and processing data from the captured photographs 130 to generate the data set. In at least some embodiments, the computing device 140 forms one or more 3-D recreations of surfaces (e.g., a plurality of point clouds 150, a contoured surface 160, or the like) of the one or more objects 110. In at least some embodiments, one or more displays 142 are coupled to the computing device 140 and are configured and arranged to display one or more of the 3-D surfaces 150 and 160.

The reference frame 112 includes a plurality of targets, such as target 114, disposed on or around a reference surface 116, and a coupling member 118 configured and arranged to rigidly couple the one or more objects 110 to the reference frame 112. In other words, the coupling member 118 couples the one or more objects 110 to the reference frame 112 such that any change in position or orientation of the one or more objects 110 causes a corresponding change in position or orientation of the reference frame 112. Thus, the coupling member 118 couples the one or more objects 110 to the reference frame 112 such that the one or more objects 110 and the reference frame 112 move together in unison with no relative movement between the one or more objects 110 and the reference frame 112. The position of the one or more objects 110 refers to the relative location of the one or more objects in a 3-D space, such as x, y, and z axes of a Cartesian coordinate system. The orientation of the one or more objects refers to the yaw, pitch, and roll of the one or more objects at a given position.

In at least some embodiments, the coupling member 118 couples the one or more objects 110 to the reference frame 112 such that the coupling member 118 does not contact or obstruct the one or more portions of the one or more objects 110 containing data points used for generating the data set of measurements. In at least some embodiments, the coupling member 118 couples the one or more objects 110 to the reference frame 112 such that the coupling member 118 is removably coupled to the one or more objects 110. In at least some embodiments, the coupling member 118 couples the one or more objects 110 to the reference frame 112 such that the coupling member 118 is removably coupled to the reference frame 112.

The coupling member 118 may employ any number of fastening devices or a fastening system suitable for rigidly attaching the one or more objects 110 to the reference frame 112 including, for example, straps, cords, cardboard, a rigid attachment frame (e.g., formed from wood, plastic, metal, or any other rigid material), hook and loop fasteners, snaps, buttons, zippers, tape, one or more adhesives, or the like or combinations thereof.

In at least some embodiments, the one or more objects 110 are internally rigid. In at least some embodiments, the one or more objects 110 are internally rigid enough to maintain a given shape long enough for the at least one camera 120 to capture at least two photographs of the one or more objects 110. In at least some embodiments, the one or more objects 110 are internally rigid enough to maintain a given shape long enough for the at least one camera 120 to capture a first photograph 130a of the one or more objects 110 from a first camera location and subsequently capture a second photograph 130b of the one or more objects 110 from a second camera location. It will be understood that there may be additional photographs captured until a final photograph 130c is captured. Any number of photographs may be captured in any number of camera locations. In at least some embodiments, the second photograph 130b is the final photograph. It will also be understood that the one or more objects 110 may change one or more of position or orientation in between the capturing of the first photograph 130a and the capturing of the final photograph 130c. It will further be understood that there may be up to (and including) as many camera locations as there are photographs 130.

In at least some embodiments, when there are a plurality of objects 110, the plurality of objects 110 move in unison such that there is no relative movement between any of the plurality of objects 110 during movement of the plurality of objects 110 as a whole. In at least some embodiments, the one or more objects 110 include a plurality of regions (e.g., individual toes of a foot, individual fingers of a hand, or the like), and each of the regions of the one or more objects 110 move in unison such that there is no relative movement between any of the regions of objects 110 during movement of the one or more objects 110 as a whole.

In FIG. 1, the one or more objects 110 are shown as an inferior surface of a foot and the coupling member 118 is shown fastened to the superior portion of the foot. In other embodiments, the one or more objects 110 are other body parts including, for example, a head, hand, arm, leg, back, stomach, neck, head, face, ear, nose, lips, tongue, elbow, knee, or the like or combinations thereof. It will be understood that the one or more objects 110 need not be one or more body parts and may, instead or in addition to, be any moving, photographable object to which a reference frame 112 may be coupled or which itself may be internally rigid.

The reference surface 116 may be any size or shape. In at least some embodiments, the reference surface 116 is planar. In at least some embodiments, the reference surface 116 is substantially planar. In at least some embodiments, the plurality of targets 114 are disposed on the reference surface 116. In at least some embodiments, the plurality of targets 114 are disposed in proximity to the reference surface 116. In at least some embodiments, the plurality of targets 114 extend outwardly from the reference surface 116.

In at least some embodiments, the reference surface 116 and the reference frame 112 are a unitary structure. In at least some embodiments, the reference surface 116 is rigidly coupled to the reference frame 112 such that any change in position or orientation of the reference frame 112 causes a corresponding change in position or orientation of the plurality of targets 114. In at least some embodiments, the plurality of targets 114 are rigidly coupled to the reference frame 112 such that any change in position or orientation of the reference frame 112 causes a corresponding change in position or orientation of the plurality of targets 114. In at least some embodiments, the plurality of targets 114, the reference surface 116, the reference frame 112, and the one or more objects 110 are all rigidly coupled together such that they all move in unison with no relative movement therebetween.

In at least some embodiments, each of the plurality of targets 114 provides a high contrast region which the computing device 140 can use to determine the relative positioning of the at least one camera 120 to the one or more objects in each of the photographs 130. In at least some embodiments, each of the plurality of targets 114 provides a high contrast region which the computing device 140 can use from different photographs 130 for creating the data set.

In at least some embodiments, each of the plurality of targets 114 is uniquely identifiable. In at least some embodiments, each of the plurality of targets 114 is uniquely identifiable in multiple photographs 130. In at least some embodiments, each of the plurality of targets 114 is uniquely identifiable by a user of system. In at least some embodiments, each of the plurality of targets 114 is uniquely identifiable by the computing device 140. In at least some embodiments, the plurality of targets 114 are coded. In at least some embodiments, the plurality of targets 114 are coded for being read by the computing device 140. In at least some embodiments, the plurality of targets 114 are coded for being manually read by a user. In at least some embodiments, the plurality of targets 114 are bar coded. In at least some embodiments, the plurality of targets 114 are circular dots. In at least some embodiments, the plurality of targets 114 employ circular bar coding. Any number of targets 114 may be employed including, for example, two, three, four, five, six, seven, eight, nine, ten, eleven, twelve or more targets 114. In at least some embodiments, as least three targets 114 are employed. In at least some embodiments, at least five targets 114 are employed.

Any number of cameras 120 may be employed to capture photographs 130 of the one or more objects 110. In at least some embodiments, a single camera 120 is used to capture all of the photographs 130. In at least some embodiments, the at least one camera 120 is mounted on a tripod. In at least some embodiments, at least one of the photographs 130 is captured from a location that is different from the location of at least one other of the captured photographs 130. In at least some embodiments, each of the photographs 130 is captured from a different location. In at least some embodiments, each of the photographs 130 includes at least a portion of the one or more objects 110 and at least a portion of one of the plurality of targets 114.

In at least some embodiments, two, three, four, five, six, seven, or eight photographs are captured. It will be understood that more than eight photographs may be captured. In at least some embodiments, the period of time between the capturing of a first photograph 130a and the capturing of the final photograph 130c is no more than 5, 10, 15, 20, 25, 30, 35, 40, 45, 50, 55, or 60 seconds. In at least some embodiments, the period of time between capturing the first photograph 130a and capturing the final photograph 130c is more than 60 seconds.

In at least some embodiments, the captured photographs 130 are input to the computing device for processing. In at least some embodiments, the computing device 140 uses the plurality of targets 114 to determine relative positioning of the at least one camera 120 (i.e., the camera positions) to the one or more objects 110 for each captured photograph 130. In at least some embodiments, the computing device 140 scans the photographs 140. In at least some embodiments, the computing device 140 matches loci (e.g., data points) on the one or more images 110 across multiple captured photographs 130. In at least some embodiments, the computing device 140 correlates data points in the photographs 130, these data points are then used to determine 3-D points on a surface of the one or more objects 110 by using triangulation methods. In at least some embodiments, the computing device 140 performs a line scan image correlation on pairs of the captured photographs 130.

In at least some embodiments, the computing device 140 outputs a data set. In at least some embodiments, the data set includes a plurality of measurements of the surface of 3-D surfaces based on data points on the surface. In at least some embodiments, further processing may be performed on the data set. For example, the data set may be measured or analyzed for forming a 3-D recreation of the object surface. In at least some embodiments, the data set output from the computing device 140 may be output to another computing device or software application, or the like, for further processing.

In at least some embodiments, the computing device 140 displays reconstructed 3-D surfaces 150 or 160 on the display 142. In at least some embodiments, the computing device 140 processes the 3-D surfaces into a 3-D point cloud 150 that includes any number of data points. In at least some embodiments, the computing device 140 processes 3-D point cloud 150 in to a triangulated surface. In at least some embodiments, the computing device 140 processes the triangulated surface into a contour map 160.

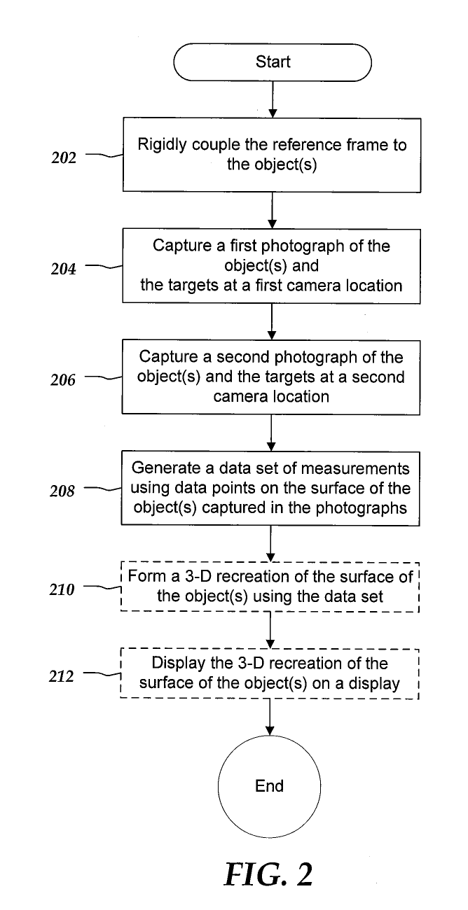

FIG. 2 is a flow diagram generally showing one embodiment of a method for capturing a plurality of photographs of one or more moving objects over time and using the photographs to photogrammetrically form a 3-D recreation of a surface of the one or more objects. In step 202, the reference frame 112 is rigidly coupled to the one or more objects 110. In step 204, a first photograph 130a is captured of the one more objects 110 and targets 114 disposed on the rigidly coupled reference frame 112 using the at least one camera 120 positioned at a first camera location. In step 206, a second photograph 130b is captured of the one more objects 110 and targets 114 disposed on the rigidly coupled reference frame 112 using the at least one camera 120 positioned at a second camera location. The one or more objects and rigidly coupled reference frame move at least some amount between the capturing of the first photograph 130a and the capturing of the second photograph 130b. In step 208, the captured photographs 130 are input to the computing device 140 to generate a data set of measurements. In at least some embodiments, the data set of measurements uses data points on the surface of the at least one object 110 captured in the photographs 130. In at least some embodiments, the data set measurements are based, at least in part, on the relative positioning of the first camera position of the at least one camera 120 to the targets 114 in the first captured photograph 130a, and the relative positioning of the second camera position of the at least one camera 120 to the targets 114 in the second captured photograph 130b. Optionally, in step 212 the 3-D recreation of the surface of the at least one object 110 is displayed on the display 142.

It will be appreciated that step 208 can be carried out by using any number of well known algorithms to compute the relative position or orientation of the at least one camera 120 at the time of capturing photographs 130. It will also be appreciated that any number of well known correlation algorithms can be employed to form a dense matched 2-D point set relative to the photographs 130, both of which (relative position of the at least one camera 120 at two or more locations and a dense matched 2-D point set) are used to compute the reconstructed 3-D surfaces 150 or 160 using triangulation methods. One of ordinary skill in the art will appreciate that there are any number of suitable algorithms that can be used to compute the relative position of the at least one camera 120 at two or more locations including, for example, a coplanarity-based, relative-orientation algorithm. Further, one of ordinary skill in the art will appreciate that there are any number of suitable correlation algorithms for forming a dense matched 2-D point set relative to the photographs 130 including, for example, the Sum of Absolute Differences Method, the Summed Squared Differences Method, or the Sara Method.

It will be understood that each block of the flowchart illustrations, and combinations of blocks in the flowchart illustrations, as well any portion of the system for creating a 3-D data set of a surface of at least one moving object disclosed herein, can be implemented by computer program instructions. These program instructions may be provided to a processor to produce a machine, such that the instructions, which execute on the processor, create means for implementing the actions specified in the flowchart block or blocks or described for the system for creating a 3-D data set of a surface of at least one moving object disclosed herein. The computer program instructions may be executed by a processor to cause a series of operational steps to be performed by the processor to produce a computer implemented process. The computer program instructions may also cause at least some of the operational steps to be performed in parallel. Moreover, some of the steps may also be performed across more than one processor, such as might arise in a multi-processor computer system. In addition, one or more processes may also be performed concurrently with other processes, or even in a different sequence than illustrated without departing from the scope or spirit of the invention.

The computer program instructions can be stored on any suitable computer-readable medium including, but not limited to, RAM, ROM, EEPROM, flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computing device.

The above specification, examples and data provide a description of the manufacture and use of the composition of the invention. Since many embodiments of the invention can be made without departing from the spirit and scope of the invention, the invention also resides in the claims hereinafter appended.

What is claimed is:

1. A method for creating a 3-D data set of a surface of at least one moving object, the method comprising
rigidly coupling a reference frame to the at least one object such that a change in position or orientation of the at least one object causes a corresponding change in position or orientation of the reference frame, the reference frame comprising a plurality of targets;
capturing a first photograph of at least a portion of the at least one object and at least some of the plurality of targets at a first camera location;
capturing a second photograph of at least a portion of the at least one object and at least some of the plurality of targets at a second camera position, wherein the at least one object moves between the capturing of the first photograph and the capturing of the second photograph; and
inputting the captured photographs into a computing device, the computing device configured and arranged to determine 3-D data points corresponding to the surface of the at least one object captured in the photographs based, at least in part, on
(1) the relative location of the first camera position with respect to the plurality of targets captured in the first photograph, and
(2) the relative location of the second camera position with respect to the plurality of targets captured in the second photograph.

2. The method of claim 1, further comprising uniquely identifying each of the plurality of targets present in the captured photographs.

3. The method of claim 2, wherein uniquely identifying each of the plurality of targets included in the captured photographs comprises using the computing device for uniquely identifying each of the plurality of targets present in the captured photographs.

4. The method of claim 1, further comprising outputting the data set to another computing device.

5. The method of claim 1, further comprising using the data set to generate a 3-D recreation of the surface of the at least one object.

6. The method of claim 5, further comprising displaying the 3-D recreation of the surface of the at least one object on a coupled display.

7. The method of claim 6, wherein creating and displaying the 3-D recreation of the surface of the at least one object on the display coupled to the computing device comprises creating and displaying a point cloud of the surface of the at least one object.

8. The method of claim 1, wherein capturing the first photograph and capturing the second photograph comprises capturing the first photograph and the second photograph using a single camera.

9. The method of claim 8, wherein capturing the first photograph at the first camera position and capturing the second photograph at the second camera position comprises capturing the first and second photographs at different locations.

10. The method of claim 1, wherein capturing a second photograph of at least a portion of the at least one object and at least some of the plurality of targets at a second camera position, wherein the at least one object moves between the capturing of the first photograph and the capturing of the second photograph comprises the at least one object and coupled reference frame moving with regards to at least one of position or orientation.

11. The method of claim 1, wherein rigidly coupling a reference frame to the at least one object such that a change in position or orientation of the at least one object causes a corresponding change in position or orientation of the reference frame, the reference frame comprising a plurality of targets comprises rigidly coupling a reference frame to the at least one object, the reference frame comprising a plurality of coded targets.

12. A system for creating a 3-D data set of a surface of at least one moving object, the system comprising:
a reference frame comprising
a reference surface, and
a coupling member, the coupling member configured and arranged to provide a rigid coupling between the at least one moving object and the reference frame such that a change in position or orientation of the at least one moving object causes a corresponding change in position or orientation of the reference frame;
a plurality of spaced-apart targets positioned on, or in proximity to, the reference surface such that the targets are positioned adjacent to a surface of the at least one moving object when the at least one moving object is rigidly coupled to the reference frame;
at least one camera configured and arranged for capturing a plurality of photographs of the at least one moving object and at least some of the plurality of targets at a plurality of camera locations; and
a processor configured and arranged for forming the 3-D data set of the surface of the at least one moving object using the captured photographs from the at least one camera, wherein the processor determines data points corresponding to the surface of the at least one moving object based, at least in part, on the relative locations of the captured targets with respect to the camera locations for each captured photograph.

13. The system of claim 12, wherein the computing device further comprises a display configured and arranged to display a 3-D recreation of the surface of at least one moving object generated by the processor.

14. The system of claim 12, wherein the plurality of targets are coded.

15. The system of claim 12, wherein the plurality of targets are bar coded.

16. The system of claim 12, wherein each of the plurality of targets are uniquely identifiable by the processor.

17. The system of claim 12, wherein each of the plurality of targets are uniquely identifiable by a human operator of the photogrammetric imaging system.

18. The system of claim 12, wherein the at least one moving object is rigid.

19. The system of claim 12, wherein the at least one moving object comprises a plurality of regions, and wherein the plurality of regions do not move relative to one another when the position or orientation of the at least one moving object changes.

20. The system of claim 12, wherein the reference frame is removably coupled to the at least one moving object.

21. The system of claim 12, wherein the at least one moving object comprises at least a portion of a body of a human or an animal.
